(19) United States
(12) Patent Application Publication
(10) Pub. No.: US 2024/0419525 A1
(43) Pub. Date: Dec. 19, 2024

(54) METHOD OF DETECTING ANOMALIES IN A PHYSICAL SYSTEM, AND CORRESPONDING MICROCONTROLLER AND COMPUTER PROGRAM PRODUCT

(71) Applicant: STMicroelectronics International N.V., Geneva (CH)

(72) Inventors: Mohamed Ali Moussa, Toulon (FR); Francois De Rochebouet, Toulon (FR)

(21) Appl. No.: 18/678,878

(22) Filed: May 30, 2024

(30) Foreign Application Priority Data
Jun. 14, 2023 (FR) 2306065

(51) Int. Cl. G06F 11/07; G06F 17/16

(52) U.S. Cl. CPC G06F 11/0754; G06F 17/16

(57) ABSTRACT

A method implemented by computer for generating a model for anomaly detection in a system includes obtaining a learning data matrix corresponding to a normal operation of the system, decomposing the learning data matrix into singular values of the matrix of learning data, calculating a new base, defining a maximum Mahalanobis distance threshold representing a limit of the normal operation of the system, and defining an anomaly detection model from the new base and from the maximum Mahalanobis distance threshold.

### CROSS-REFERENCE TO RELATED APPLICATIONS

This application claims the benefit of French Patent Application No. 2306065, filed on Jun. 14, 2023, which application is hereby incorporated herein by reference.

### TECHNICAL FIELD

Anomaly detection (or “outlier detection”) is a technique used for identifying data that significantly differ from other data. These different data are often referred to as “anomalies” or “aberrant values”.

### BACKGROUND

Anomaly detection finds an interest in many applications. Some applications use microcontrollers that can be configured to implement anomaly detection.

Anomaly detection implemented by a microcontroller makes it possible to monitor in real time to detect abnormal behaviors in a physical system using data acquired by at least one sensor in this system. This technique can be used in a variety of fields such as automobile, aerospace, energy, manufacturing production, health monitoring and many others.

There are several anomaly detection techniques. Some methods are based on machine learning. These methods use machine learning algorithms to identify any data that do not correspond to the learned model.

In the context of anomaly detection, a microcontroller generally uses a model that represents the normal behavior of a system to analyze data collected by at least one sensor in the system.

In particular, the model is used to compare the current data collected by the at least one sensor with those of the normal behavior. If the current data differ too much from the expected ones, this may indicate an anomaly or a malfunctioning in the system. In this case, an alert can be triggered to warn an operator of the system.

The anomaly detection implemented therefore makes it possible to warn of breakdowns and failures of the system. This makes it possible to improve the reliability and safety of the system.

The model used for detecting anomalies can be obtained using a machine learning algorithm. A computer server can be used to implement the machine learning algorithm for obtaining the model.

In particular, the machine learning algorithm is configured to generate a model for anomaly detection using data representing a normal behavior of a system. Using such a machine learning algorithm has the advantage of avoiding supplying aberrant data to the machine learning algorithm to generate the model. This is because it may be difficult and expensive to intentionally generate anomalies in a system to obtain aberrant data.

The known models that can be generated by such machine learning algorithms generally have the drawback of including numerous parameters that involve a relatively complex processing of the data by the microcontroller and occupying a large amount of memory space of the microcontroller.

There is therefore a need to propose a solution for obtaining a model for anomaly detection that is simple to implement by a microcontroller.

### SUMMARY

According to one aspect, a method implemented by computer for generating a model for anomaly detection in a physical system is proposed, the method comprising:
obtaining a matrix of learning data corresponding to a normal operation of the system,
decomposing the learning data matrix into singular values, so as to obtain an orthogonal input matrix, a diagonal matrix and an orthogonal output matrix,
determining a rank of the learning data matrix having energy higher than a threshold from the diagonal matrix,
calculating a new base formed by columns of the orthogonal input matrix selected according to the rank determined,
defining a maximum Mahalanobis distance threshold representing a limit of the normal operation of the system,
defining an anomaly detection model from the new base and from the maximum Mahalanobis distance threshold.

Such a method it uses a decomposition into singular values and a maximum Mahalanobis distance threshold to define the anomaly detection model. Decomposing into singular values makes it possible to obtain an anomaly detection model robust to noise and to disturbances.

Decomposing into singular values also make it possible to systematically obtain an invertible matrix of the projected learning data. It is thus always possible to calculate a Mahalanobis distance from this invertible matrix.

The model obtained can then be integrated in a microcontroller of the system in order to implement a detection of anomalies during the operation of this system. Such a model has the advantage of occupying a relatively small memory space.

In an advantageous embodiment, defining the maximum Mahalanobis distance threshold comprises:
projecting the learning data onto the new base,
calculating a Mahalanobis distance for each of the learning data,
defining the maximum Mahalanobis distance threshold from the Mahalanobis distances calculated.

Advantageously, the method further comprises calculating a covariance matrix and a precision matrix from the projected learning data and from a mean of the projected learning data, the calculation of the Mahalanobis distance being done from the projected learning data, from the precision matrix and from the mean calculated, and in which the defined anomaly detection model further comprises the precision matrix and the mean.

In a variant, defining the maximum Mahalanobis distance threshold comprises defining the maximum Mahalanobis distance threshold from a chi-square table.

In a variant, in an advantageous embodiment, the method further comprises transforming the new base, this transformation being adapted to standardize the projected learning data, the anomaly detection model then comprising the new transformed base and the maximum Mahalanobis distance threshold.

This transformation makes it possible to avoid storing the precision matrix in the anomaly detection model since the precision matrix then corresponds to the identity matrix. Thus the anomaly detection model comprises only the new transformed base and the maximum Mahalanobis distance threshold.

According to another aspect, a method implemented by computer for anomaly detection in a physical system is proposed, comprising:
obtaining an anomaly detection model generated from a generation method as previously described from learning data corresponding to a normal operation of the system,
obtaining data representing the operation of the system,
projecting the data representing the operation of the system onto the base of the anomaly detection model,
calculating a Mahalanobis distance from the projected data,
comparing the calculated Mahalanobis distance with the maximum Mahalanobis distance threshold defined in the anomaly detection model,
detecting anomalies if the calculated Mahalanobis distance is greater than the maximum Mahalanobis distance threshold.

Such a method has the advantage of being able to be implemented by a microcontroller. This is because the latter implements only two operations, projecting the data representing the operation of the system onto the base of the model, and calculating the Mahalanobis distance.

Advantageously, the calculation of the Mahalanobis distance is done using the projected data, the precision matrix and the mean of the anomaly detection model.

According to another aspect, a computer program product is provided comprising instructions which, when the program is executed by a computer, cause the latter to implement a method for generating an anomaly detection model as described before.

According to another aspect, a computer program product is provided comprising instructions which, when the program is executed by a computer, cause the latter to implement an anomaly detection method as described before.

According to another aspect, a microcontroller is proposed comprising:
a non-transitory memory in which a computer program for detecting anomalies as described before is recorded,
a processing unit or processor configured to execute this computer program.

### BRIEF DESCRIPTION OF THE DRAWINGS

Other advantages and features of the invention will become apparent upon examining the detailed description of in no way limitative embodiments, and from the appended drawings wherein:

FIG. 1 illustrates a first embodiment of a method for generating an anomaly detection model;

FIG. 2 illustrates a second embodiment of a method for generating an anomaly detection model;

FIG. 3 illustrates a microcontroller configured to implement an anomaly detection method in a matrix of data; and

FIG. 4 illustrates a method used by a microcontroller to implement anomaly detection in a matrix of data.

### DETAILED DESCRIPTION OF ILLUSTRATIVE EMBODIMENTS

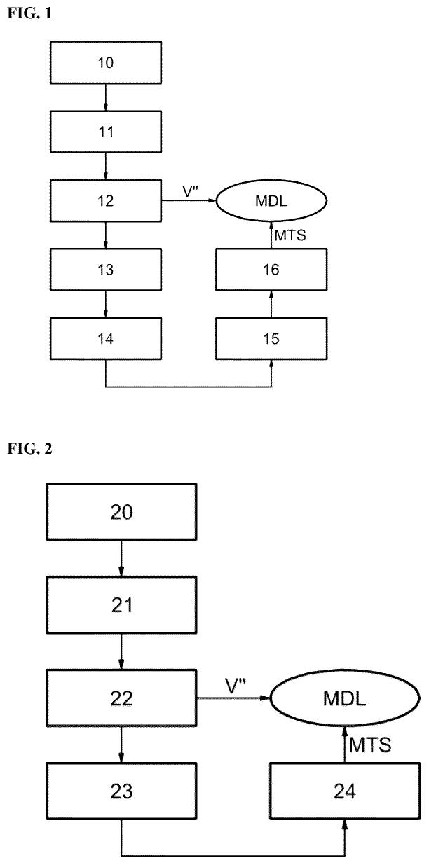

FIG. 1 illustrates a first embodiment of a method for generating an anomaly detection model. This method for generating an anomaly detection model is implemented by computer.

Such a method is used for defining a model determining limits of normal behavior of a physical system.

In particular, such a method can be implemented by a computer server. The server then includes a non-transitory memory in which a computer program is stored, comprising instructions which, when they are implemented by the server, cause the latter to implement the generation method.

The method comprises a step 10 of obtaining learning data. In this step 10, learning data are supplied to the server. The learning data are data representing normal behavior of a physical system. These data can for example be acquired by at least one sensor of this system during normal operation of the system.

The learning data are grouped in a matrix X. The matrix X has for example a size m×n.

The method next comprises a step 11 of implementing a decomposition into singular values. In this step 11, the server proceeds with a decomposition of the matrix X into singular values. This step 11 makes it possible to factorize the matrix X of learning data into three matrices U, Σ et V. In particular, the matrices U, Σ et V are defined so that the matrix X corresponds to the matrix product UΣVT. The matrix U is then an orthogonal matrix of size m×m. The matrix Σ is a diagonal matrix of size m×n containing the singular values of the matrix X (i.e. the square roots of the eigenvalues of the matrix XTX or XXT), and V is an orthogonal matrix of size n×n.

The matrix V contains a matrix of orthonormal basis vectors of Kⁿ, referred to as “input vectors”. The matrix V is therefore an orthonormal input matrix.

The matrix U contains a matrix of orthonormal basis vectors of K^{m}, referred to as “output vectors”. The matrix U is therefore an orthonormal output matrix.

This singular value decomposition makes it possible to reduce the dimensionality of the matrix X of learning data while preserving the important properties of the matrix X. Decomposing into singular values therefore makes it possible to compress the matrix X and to reduce its occupation of the memory while keeping only the vectors that correspond to the most important singular values.

The method then comprises a step 12 of calculating a new base. In this step 12, the server calculates a new base V′ from the matrix Σ obtained by means of the decomposition into singular values.

In particular, the step 12 of calculating the new base V′ comprises determining a rank of the matrix of learning data that has an energy corresponding to a predefined energy threshold. More particularly, the total energy of the matrix of learning data corresponds to the sum of the squares of the singular values of this matrix, the singular values being contained in the diagonal matrix Σ obtained by the singular value decomposition. The rank determined at this step 12 corresponds to the rank of the matrix of learning data that has an energy reaching the predefined energy threshold (i.e. the number of singular values making it possible to reach this energy threshold). The energy threshold can correspond to a percentage predefined with respect to the total energy of the matrix of learning data.

The step 12 of calculating the new base comprises selecting the columns of the matrix V that correspond to the determined rank of the matrix of learning data. The columns of the matrix V then form a new base V′. This new base V makes it possible to keep only the columns of the base V corresponding to the most important singular values (i.e. those that most contribute to the total energy of the matrix).

The method then comprises a projection step 13. In this step 13, the server projects the learning data onto the new base V′. The projection corresponds to a matrix product between the learning data and the new base V′.

The server thus obtains a matrix of the projection. This matrix of the projection is systematically an invertible matrix.

The method then comprises a transformation step 14. In this transformation step 14, the server uses an algorithm for standardizing the data of the matrix of the projection. This step 14 makes it possible to calculate a transformed base V″. In particular, the transformed base V″ can be obtained in accordance with the following expression:

$${V}^{″} = \frac{1}{\sqrt{n - 1}} \times {S}^{′} \times {V}^{′} ,$$

where n represents the number of rows in the learning matrix, V′ is the new base and S′ is a truncated diagonal matrix of the singular value decomposition.

This step 14 makes it possible to obtain a centered unitary variance matrix from the matrix of the projection. The matrix obtained is centered around zero. This transformation makes it possible to obtain a precision matrix corresponding to an identity matrix.

The method then comprises a step 15 of calculating Mahalanobis distances. In this step 15, the server calculates a Mahalanobis distance for each of the learning data. Each Mahalanobis distance can be calculated since the covariance matrix that corresponds to the projection is systematically invertible, because of the singular value decomposition and taking account only of the components having a large singular value.

In particular, the Mahalanobis distance is calculated using the formula:

$${D}_{M} ( x ) = \sqrt{{( x - μ )}^{T} {\sum }^{- 1} ( x - μ )}$$

where x is a vector that corresponds to a projected data item, μ is a vector that corresponds to a mean of the projected learning data, and Σ⁻¹ corresponds to the precision matrix (i.e. the inverse of the covariance matrix).

By applying step 14, the Mahalanobis distance is reduced to the Euclidean distance. It can be expressed as follows: D_{M}(x)=\sqrt{(x−μ)^{T}(x−μ)} where x is a vector that corresponds to a projected and standardised data item, u is a vector that corresponds to a mean of the projected and standardized learning data.

The method then comprises a step 16 of defining a maximum Mahalanobis distance threshold. In this step, the server defines a maximum Mahalanobis distance threshold. This maximum Mahalanobis distance threshold represents a limit of a normal behavior of the system. For example, the maximum threshold is defined as a distance that is greater than the Mahalanobis distance associated with 98% of the normal data projected onto the base V′ and standardized.

An anomaly detection model is then defined. This anomaly detection model includes the base V′, the precision matrix and the maximum Mahalanobis distance threshold. In a variant, the detection model includes only the transformed base V″ and the maximum Mahalanobis distance threshold using step 14 since the precision matrix is then the identity matrix, which is known and therefore does not require to be stored.

This anomaly detection model is next integrated in a microcontroller of the system. In particular, the anomaly detection model is stored in a non-transitory memory of the microcontroller. Such a detection model has the advantage of occupying relatively little space in the memory of the microcontroller.

FIG. 2 illustrates a second embodiment of a method for generating an anomaly detection model.

Such a method is used for defining a model determining limits of normal behavior of a physical system.

In particular, such a method can be implemented by a computer server. The server then includes a non-transitory memory in which a computer program is stored, comprising instructions which, when they are implemented by the server, cause the latter to implement the generation method.

The method comprises a step 20 of obtaining learning data. In this step 20, learning data are supplied to the server. The learning data are data representing normal behavior of a system. These data can for example be acquired by at least one sensor of this system during normal operation of the system.

The learning data are grouped in a matrix X. The matrix X has for example a size m×n.

The method next comprises a step 21 of implementing a decomposition into singular values. In this step 21, the server proceeds with a decomposition of the matrix X into singular values. This step 21 makes it possible to factorize the matrix X of learning data into three matrices U, Σ et V. In particular, the matrices U, Σ et V are defined so that the matrix X corresponds to the matrix product UΣVT. The matrix U is then an orthogonal matrix of size m×m. The matrix Σ is a diagonal matrix of size m×n containing the singular values of the matrix X (i.e. the square roots of the eigenvalues of the matrix XTX or XXT), and V is an orthogonal matrix of size n×n.

The matrix V contains a matrix of orthonormal basis vectors of Kⁿ, referred to as “input vectors”. The matrix V is therefore an orthonormal input matrix.

The matrix U contains a matrix of orthonormal basis vectors of K^{m}, referred to as “output vectors”. The matrix U is therefore an orthonormal output matrix.

This singular value decomposition makes it possible to reduce the dimensionality of the matrix X of learning data while preserving the important properties of the matrix X. Decomposing into singular values therefore makes it possible to compress the matrix X and to reduce its occupation of the memory while keeping only the vectors that correspond to the most important singular values.

The method then comprises a step 22 of calculating a new base V′. In this step 22, the server calculates a new base V′ from the matrix 2 obtained by means of the singular value decomposition.

In particular, the step 22 of calculating the new base V′ comprises determining a rank of the matrix of learning data that has an energy corresponding to a predefined energy threshold.

The step 22 of calculating the new base comprises selecting the columns of the matrix V that correspond to the determined rank of the matrix of learning data. The columns of the matrix V then form a new base V′.

The method then comprises a transformation step 23. This step 23 makes it possible to calculate a transformed base V″. In particular, the transformed base V″ corresponds to the following expression:

$${V}^{″} = \frac{1}{\sqrt{n - 1}} \times {S}^{′} \times {V}^{′} ,$$

where n represents the number of rows in the learning matrix, V′ is the new base and S′ is a truncated diagonal matrix of the singular value decomposition.

The method next comprises a step 24 defining a maximum Mahalanobis distance threshold. In this step, the server defines a maximum Mahalanobis distance threshold. This maximum Mahalanobis distance threshold represents a limit of a normal behavior of the system. In this embodiment, the maximum Mahalanobis distance threshold is defined from a chi-square table. This is because the Mahalanobis distance follows the chi-square law. It is thus possible to define the maximum Mahalanobis distance threshold from such a table.

An anomaly detection model is then defined. This anomaly detection model includes the base V′, the precision matrix and the maximum Mahalanobis distance threshold. In a variant, the detection model includes only the transformed base V″ and the maximum Mahalanobis distance threshold using step 14 since the precision matrix is then the identity matrix, which is known and therefore does not require to be stored.

This anomaly detection model is finally integrated in a microcontroller of the system. In particular, the anomaly detection model is stored in a non-transitory memory of the microcontroller. Such a detection model has the advantage of occupying relatively little space in the memory of the microcontroller.

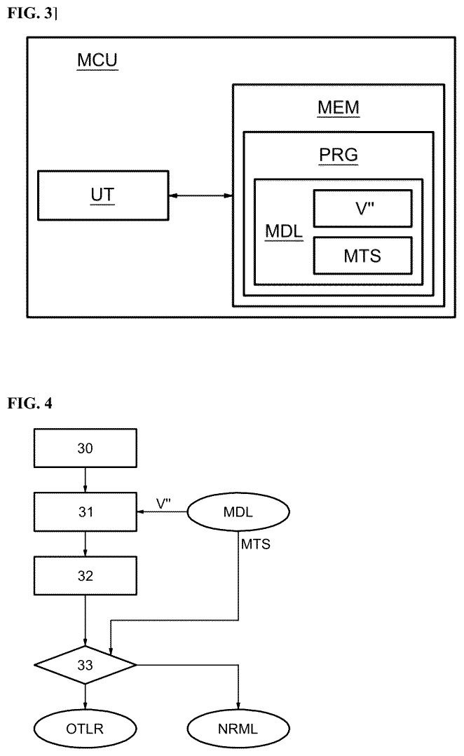

FIG. 3 illustrates a microcontroller MCU configured to implement an anomaly detection method in a matrix of data. Such a method is described hereinafter in relation to FIG. 4.

The microcontroller MCU comprises a processor UT and a non-transitory memory MEM. The non-transitory memory MEM comprises a computer program PRG comprising instructions which, when they are implemented by the processor UT of the microcontroller cause the latter to implement the anomaly detection method.

The computer program PRG includes the model MDL defined by the model-generation method described previously. In particular, the model MDL comprises the new transformed base V″ and the maximum Mahalanobis distance threshold MTS of the anomaly detection model. In a variant, the model MDL can comprise the new base V′, the precision matrix and the maximum Mahalanobis distance threshold.

The microcontroller can be integrated in a system for which monitoring of operating anomalies is required. The microcontroller can be configured to receive data acquired by a sensor of the system. These acquired data then represent the operation of the system.

FIG. 4 illustrates a method used by the microcontroller to implement anomaly detection in a matrix of data representing operation of a system.

The method comprises a step 30 of obtaining a matrix of data to be analyzed. In this step 30, the microcontroller obtains a vector of data to be analyzed. These data to be analyzed can be obtained from a sensor of the system.

The method then comprises a projection step 31. In this step 31, the data to be analyzed are projected onto the transformed base V″ of the anomaly detection model stored in the non-transitory memory of the microcontroller. The projection corresponds to a matrix product between the data to be analyzed and the transformed base V″.

This projection of the data to be analyzed makes it possible to obtain a vector of projected data.

The method then comprises a step 32 of calculating a Mahalanobis distance. In this step 32, the microcontroller calculates a Mahalanobis distance from the projected and standardized data.

The method then comprises a step 33 of determining the presence of anomalies in the matrix of data. In this step 34, the microcontroller compares the value of the calculated Mahalanobis distance with the maximum threshold stored in the non-transitory memory of the microcontroller.

If the value of the calculated Mahalanobis distance is below the maximum threshold, then the microcontroller considers that the vector of data represents normal behavior of the system (state NRML on FIG. 3).

If the value of the calculated Mahalanobis distance is above the maximum threshold, then the microcontroller considers that the vector of data represents a presence of anomalies in the behavior of the system (state OTLR on FIG. 3). In this case, the microcontroller can generate an alert signal to inform the user of the system of a malfunctioning of the system. Such a detection method is useful when access to abnormal data is limited or costly. One example is in rotatory machine failure prediction. That is, most industrial processes don't have abnormal data for their rotary machines. Thus, they can employ embodiment anomaly presence detection using acceleration data to detect various type of rotary machine faults such as bearing failure, misalignment, and imbalance. In response to detection of a fault, an operator alert signal can be generated, or the machine's operation can be modified (e.g., slowed down) or stopped directly by the controller. Another example is detecting abnormal behavior in sensor networks, in which embodiment anomaly presence detection can be used to detect the occurrence of abnormal events such as a forest fire or air pollution, and to generate a corresponding alert signal.

Naturally, the present invention is capable of various variants and modifications that will appear to a person skilled in the art. For example, instead of implementing a transformation standardizing the projection of the learning data onto the base, the method for generating an anomaly detection model can comprise a calculation of a covariance matrix, of a precision matrix (i.e. the inverse of the covariance matrix) and of a mean from the projection of the learning data onto the new base V′. The Mahalanobis distance calculated in this generation method is then obtained using this precision matrix and the calculated mean. The detection model generated then also comprises this precision matrix and the calculated mean. In this case, the anomaly detection method comprises a calculation of the Mahalanobis distance using this precision matrix and the stored mean.

Nevertheless, projecting data onto the transformed base makes it possible not to calculate the precision matrix since the latter corresponds to the identity matrix in this case. This transformation then also makes it possible to avoid storing the precision matrix in the microcontroller.

What is claimed is:

1. A method, implemented by a computer, for generating an anomaly detection model in a physical system, the method comprising:
obtaining a learning data matrix comprising learning data and corresponding to a normal operation of the physical system;
decomposing the learning data matrix into singular values of the learning data matrix, so as to generate an orthogonal input matrix, a diagonal matrix, and an orthogonal output matrix;
determining a rank of the learning data matrix having energy higher than a threshold from the diagonal matrix;
calculating a new base having columns of the orthogonal input matrix selected according to the determined rank;
generating a maximum Mahalanobis distance threshold representing a limit of the normal operation of the physical system; and
generating the anomaly detection model from the new base and from the maximum Mahalanobis distance threshold.

2. The method according to claim 1, wherein generating the maximum Mahalanobis distance threshold comprises:
projecting the learning data onto the new base;
calculating an individual Mahalanobis distance for each of the learning data; and
generating the maximum Mahalanobis distance threshold from the calculated individual Mahalanobis distances.

3. The method according to claim 2, further comprising calculating a covariance matrix and a precision matrix from the projected learning data and from a mean of the projected learning data, the calculating the individual Mahalanobis distance comprising calculating the individual Mahalanobis distance from the projected learning data, from the precision matrix, and from the mean, and the generated anomaly detection model further comprising the precision matrix and the mean.

4. The method according to claim 1, wherein generating the maximum Mahalanobis distance threshold comprises generating the maximum Mahalanobis distance threshold from a chi-square table.

5. The method according to claim 2, further comprising transforming the new base to standardize the projected learning data, the anomaly detection model comprising the transformed new base and the maximum Mahalanobis distance threshold.

6. The method according to claim 1, further comprising:
obtaining operational data representing an actual operation of the physical system;
projecting the operational data representing the actual operation of the physical system onto the new base of the anomaly detection model;
calculating a projected Mahalanobis distance from the projected operational data;
comparing the calculated projected Mahalanobis distance with the maximum generated Mahalanobis distance threshold; and
detecting anomalies in response to the calculated projected Mahalanobis distance being greater than the maximum Mahalanobis distance threshold.

7. The method according to claim 6, wherein calculating the projected Mahalanobis distance is performed using the projected operational data, a precision matrix, and a mean of the anomaly detection model.

8. A non-transitory computer-readable media storing computer instructions for generating an anomaly detection model in a physical system that, when executed by a processor, cause the processor to perform the steps of:
obtaining a learning data matrix comprising learning data and corresponding to a normal operation of the physical system;
decomposing the learning data matrix into singular values of the learning data matrix, so as to generate an orthogonal input matrix, a diagonal matrix, and an orthogonal output matrix;
determining a rank of the learning data matrix having energy higher than a threshold from the diagonal matrix;
calculating a new base having columns of the orthogonal input matrix selected according to the determined rank;
generating a maximum Mahalanobis distance threshold representing a limit of the normal operation of the physical system; and
generating the anomaly detection model from the new base and from the maximum Mahalanobis distance threshold.

9. The non-transitory computer-readable media according to claim 8, wherein the computer instructions that cause the processor to generate the maximum Mahalanobis distance threshold comprise further computer instructions that cause the processor to perform the following steps of:
projecting the learning data onto the new base;
calculating an individual Mahalanobis distance for each of the learning data; and
generating the maximum Mahalanobis distance threshold from the calculated individual Mahalanobis distances.

10. The non-transitory computer-readable media according to claim 9, storing further computer instructions that cause the processor to perform the steps of:
calculating a covariance matrix and a precision matrix from the projected learning data and from a mean of the projected learning data, the calculating the individual Mahalanobis distance comprising calculating the individual Mahalanobis distance from the projected learning data, from the precision matrix, and from the mean, and the generated anomaly detection model further comprising the precision matrix and the mean.

11. The non-transitory computer-readable media according to claim 8, wherein the computer instructions that cause the processor to generate the maximum Mahalanobis distance threshold comprise further computer instructions that cause the processor to perform the following step of:
generating the maximum Mahalanobis distance threshold from a chi-square table.

12. The non-transitory computer-readable media according to claim 9, storing further computer instructions that cause the processor to perform the step of:
transforming the new base to standardize the projected learning data, the anomaly detection model comprising the transformed new base and the maximum Mahalanobis distance threshold.

13. The non-transitory computer-readable media according to claim 8, storing further computer instructions that cause the processor to perform the steps of:
obtaining operational data representing an actual operation of the physical system;
projecting the operational data representing the actual operation of the physical system onto the new base of the anomaly detection model;
calculating a projected Mahalanobis distance from the projected operational data;
comparing the calculated projected Mahalanobis distance with the maximum generated Mahalanobis distance threshold; and
detecting anomalies in response to the calculated projected Mahalanobis distance being greater than the maximum Mahalanobis distance threshold.

14. A microcontroller configured to generate an anomaly detection model in a physical system, the microcontroller comprising:
a non-transitory memory comprising instructions; and
a processor in communication with the non-transitory memory, wherein the processor executes the instructions to:
obtain a learning data matrix comprising learning data and corresponding to a normal operation of the physical system;
decompose the learning data matrix into singular values of the learning data matrix, so as to generate an orthogonal input matrix, a diagonal matrix, and an orthogonal output matrix;
determine a rank of the learning data matrix having energy higher than a threshold from the diagonal matrix;
calculate a new base having columns of the orthogonal input matrix selected according to the determined rank;
generate a maximum Mahalanobis distance threshold representing a limit of the normal operation of the physical system; and
generate the anomaly detection model from the new base and from the maximum Mahalanobis distance threshold.

15. The microcontroller according to claim 14, wherein the processor executing the instructions to generate the maximum Mahalanobis distance threshold comprises the processor executing the instructions to:
project the learning data onto the new base;
calculate an individual Mahalanobis distance for each of the learning data; and
generate the maximum Mahalanobis distance threshold from the calculated individual Mahalanobis distances.

16. The microcontroller according to claim 15, further comprising the processor executing the instructions to:
calculate a covariance matrix and a precision matrix from the projected learning data and from a mean of the projected learning data, the calculating the individual Mahalanobis distance comprising calculating the individual Mahalanobis distance from the projected learning data, from the precision matrix, and from the mean, and the generated anomaly detection model further comprising the precision matrix and the mean.

17. The microcontroller according to claim 14, wherein the processor executing the instructions to generate the maximum Mahalanobis distance threshold comprises the processor executing the instructions to generate the maximum Mahalanobis distance threshold from a chi-square table.

18. The microcontroller according to claim 15, further comprising the processor executing the instructions to transform the new base to standardize the projected learning data, the anomaly detection model comprising the transformed new base and the maximum Mahalanobis distance threshold.

19. The microcontroller according to claim 14, further comprising the processor executing the instructions to:
obtain operational data representing an actual operation of the physical system;
project the operational data representing the actual operation of the physical system onto the new base of the anomaly detection model;
calculate a projected Mahalanobis distance from the projected operational data;
compare the calculated projected Mahalanobis distance with the maximum generated Mahalanobis distance threshold; and
detect anomalies in response to the calculated projected Mahalanobis distance being greater than the maximum Mahalanobis distance threshold.

20. The microcontroller according to claim 19, wherein the processor executing the instructions to calculate the projected Mahalanobis distance comprises the processor executing the instructions to use the projected operational data, a precision matrix, and a mean of the anomaly detection model.
